(19) United States
(12) Patent Application Publication
(10) Pub. No.: US 2017/0037588 A1
(43) Pub. Date: Feb. 9, 2017

(54) No Mess Poop Scooper

(71) Applicant: Melvin William Huitt, Auburndale, FL (US)

(72) Inventor: Melvin William Huitt, Auburndale, FL (US)

(21) Appl. No.: 15/194,329

(22) Filed: Jun. 27, 2016

Related U.S. Application Data
(60) Provisional application No. 62/282,473, filed on Aug. 3, 2015.

(51) Int. Cl. E01H 1/00; B25G 1/00; A01K 1/035

(52) U.S. Cl. CPC E01H 1/006; A01K 1/035; B25G 1/00

(57) ABSTRACT

A sanitary way of picking up pet waste by removing the Poop Scooper from the Belt Clip, removing a bag from the bag holder, putting a bag over the poop scooper, holding it on with an o ring, opening the poop clamps, tucking the bag inside of the poop scooper clamps. Opening the poop clamps placing the open poop scooper over the pet waste. Then closing it, picking up the waste. Removing the o ring from the bag, pull the bag down over the clamps. Tie the open end of the bag, open the poop scooper, remove the bag and dispose of it. Place the Poop Scooper back in the Belt Clip. And do it all without touching any poop.

### CROSS-REFERENCE TO RELATED APPLICATIONS

Provisional Patent—62/282,473

Filing Date 2015 Aug. 3

### FEDERALLY SPONSORED RESEARCH OR DEVELOPMENT

Not Applicable

### NAMES OF THE PARTIES TO A JOINT RESEARCH AGREEMENT

Not Applicable

### REFERENCE TO A SEQUENCE LISTING

Not Applicable

### BACKGROUND

There are more and more cities, parks, and places around that require pet owners to not leave their pet waste laying on the ground, making them pick it up. Owners have the option of picking up the pet waste with their bare hand, hand in a bag or a scooper that they have to scrape and wash off.

### SUMMARY

The present invention presents a sanitary way of picking up and disposing of pet waste.

Other aspect of the invention is that a bag is removed from the bag holder, the bag is placed over the clamp end of the poop scooper, it is held in place with an o ring at the top of the clamp.

There is also a clip for holding the poop scooper to your belt. So that when you walk your pet the poop scooper will be handy.

You just remove the poop scooper from the belt dip. Remove a bag from the holder for a roll of bags, install the bag that is held on by an o ring. And pick up the pet waste.

The scooper comprising of a handle with two parts a top and a bottom with springs on the inside. The bottom handle has a connecting tube attached. At the bottom of the connecting tube is an end stop. The top handle has a push rod screwed into it, going down through the connecting tube to the clamp springs where it is attached by a top nut, top washer, a bottom washer and a bottom nut. The clamp springs are fixed to the clamps by bolts and nuts. The clamps are attached to the connecting tube just above the end stop by a connecting tube hinge with two bolts and nuts one on each side. The connecting tube hinge has two hinge pins, one on each side, connecting it to the clamps.

### BRIEF DESCRIPTION OF DRAWINGS

FIG. 1 Shows the Poop Scooper in the Closed position with a bag [18] on. Also shows the Holder for a Roll of Bags [6], O Ring [7] for holding the Bag [18], Hinge Bolt and Nut [8A], Hinge Pin [8B].

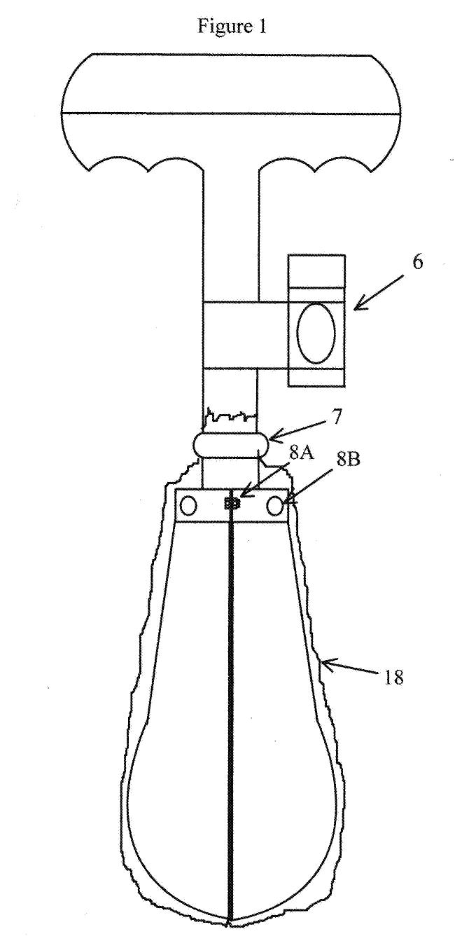

FIG. 2 Shows the Poop Scooper in the Open position with a bag [18] on. Also shows the Holder for a Roll of Bags [6], O Ring [7] for holding the Bag [18], Hinge Bolt and Nut [8A], Hinge Pin [8B].

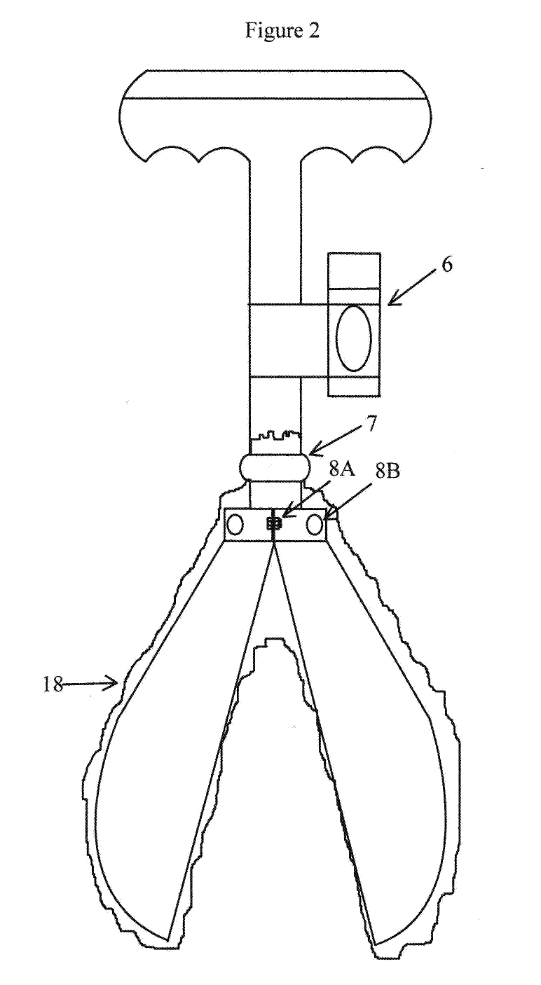

FIG. 3 Shows a cut away of the Duel Spring Poop Scooper. Showing the Handle Top [1], the Handle Bottom [2], the Handle Springs [3], the Push Rod [4], the Connecting Tube [5], the Holder for a Roll of Bags [6], O Ring for Holding Bag [7], Connecting Tube Hinge [8], Connecting Tube End Stop [9], Push Rod Top Nut [10], Push Rod Top Washer [11], Poop Clamp Springs [12] Push Rod Bottom Washer [13], Push Rod Bottom Nut [14], Poop Clamp [15], Poop Clamp Spring Nuts and Bolts [16]

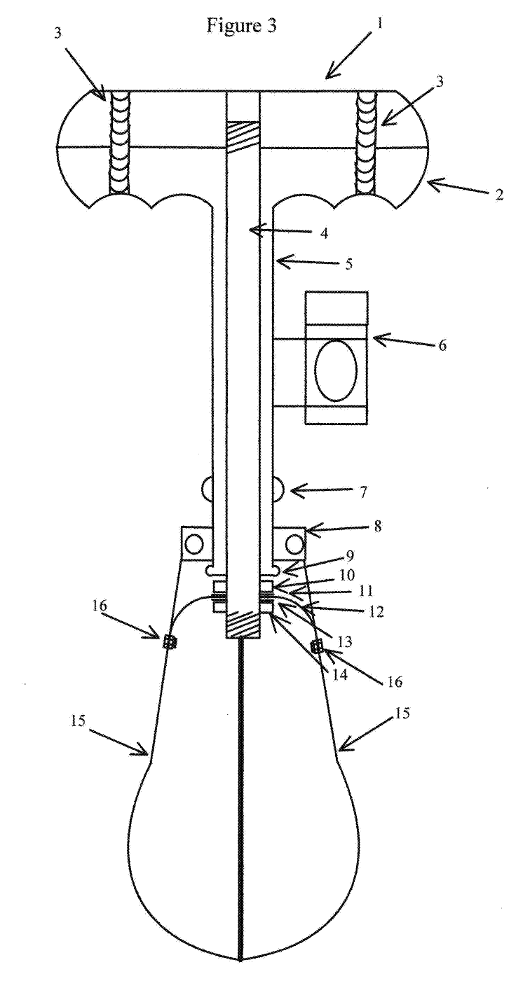

FIG. 4 Shows an Exploded View of the Connecting Tube Hinge [8], the Connecting Tube End Stop [9], the Push Rod Top Nut [10], the Push Rod Top Washer [11], the Poop Clamp Springs [12], Push Rod Bottom Washer [13], Push Rod Bottom Nut [14], Poop Clamp [15] Poop Clamp Spring Nuts and Bolts [16]

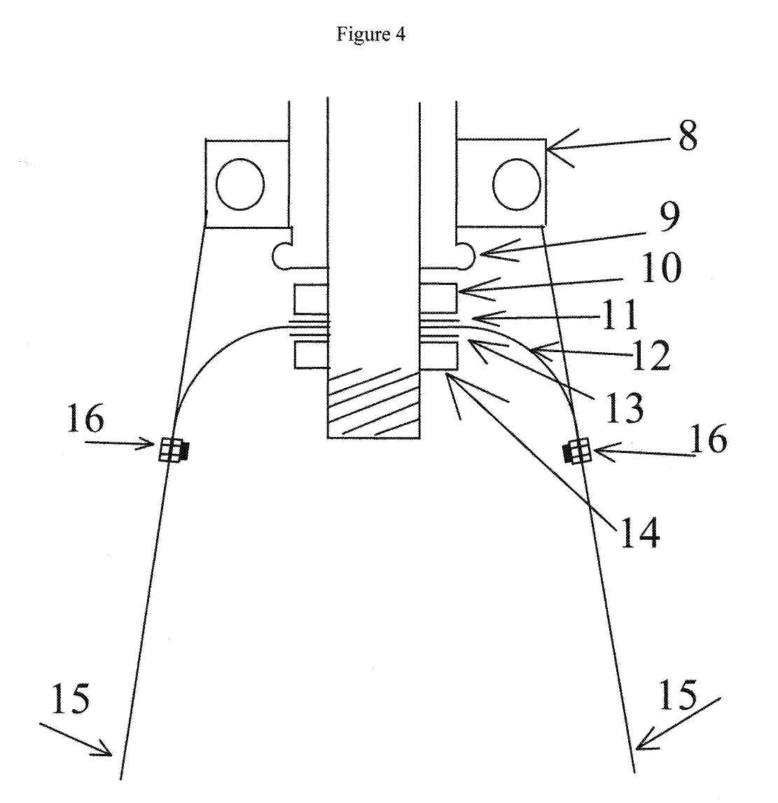

FIG. 5 Shows a side view of the Belt Clip [17] to hold Poop Scooper and a front view of the Belt Clip [17] to hold Poop Scooper

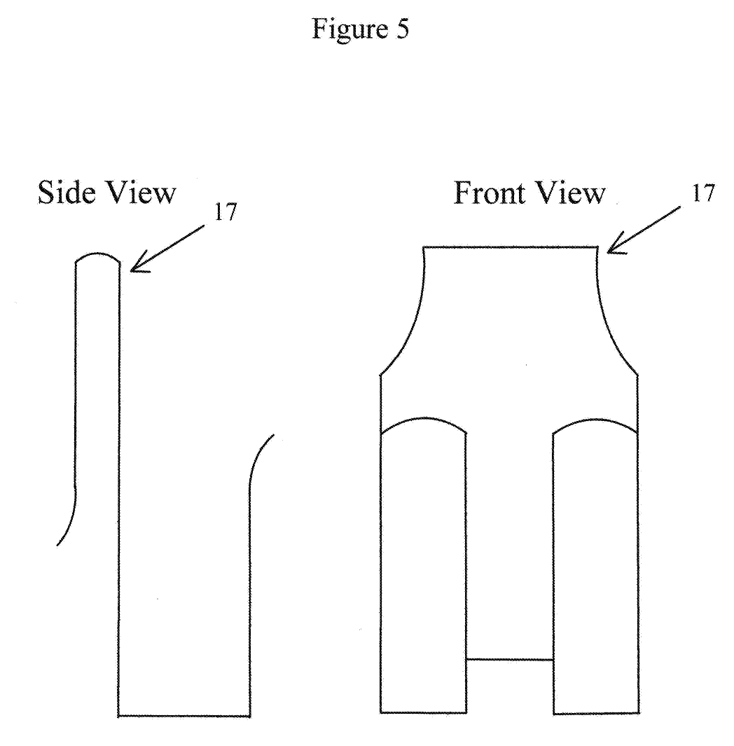

FIG. 6 Shows a cut away of the single spring Poop Scooper. Showing the Handle Top [1], the Handle Bottom [2] the Handle Spring [3], the Push Rod [4] the Connecting Tube [5], the Holder for a Roll of Bags [6], O Ring for Holding Bag [7], Connecting Tube Hinge [8], Connecting Tube End Stop [9], Push Rod Top Nut [10], Push Rod Top Washer [11], Poop Clamp Spring [12], Push Rod Bottom Washer [13], Push Rod Bottom Nut [14], Poop Clamp [15], Poop Clamp Spring Bolt and Nut [16]

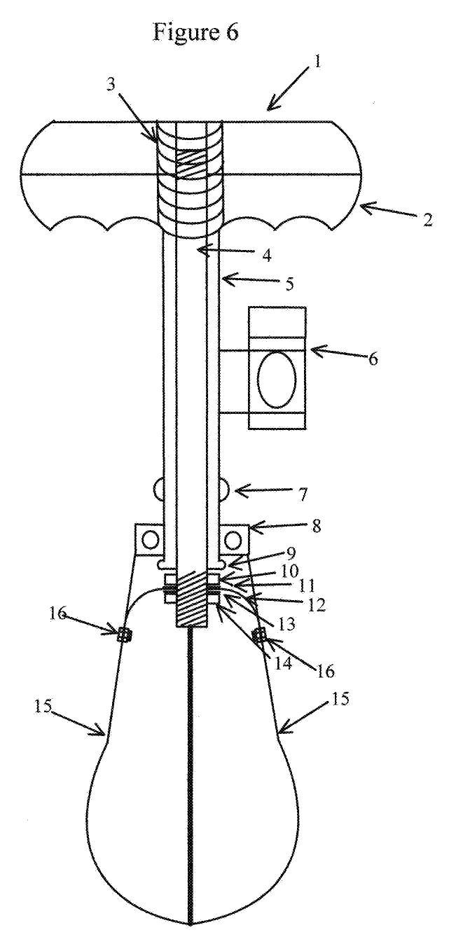

FIG. 7 Shows a cross reference between the part number and name of the parts for the Poop Scooper

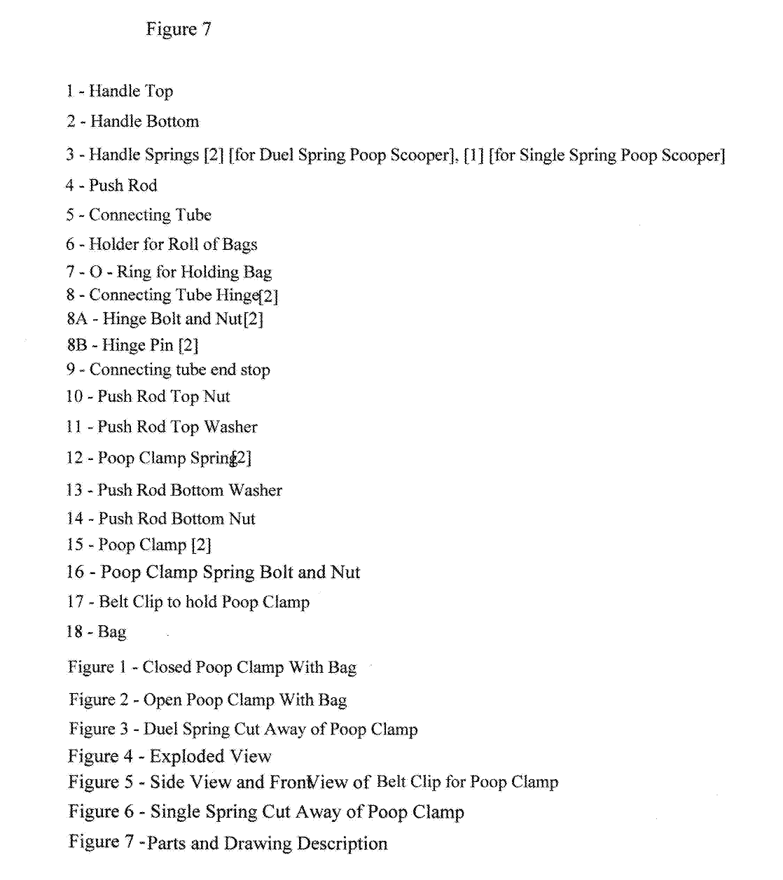

### DETAILED DESCRIPTION OF THE INVENTION

### How to Build

To build the poop scooper slide the o ring [7] over the connecting tube [5] and down about half way of the connecting tube [5] and then glue the connecting tube [5] into the handle bottom [2]. Then take the push rod [4] and screw it into the handle top [1]. Slide the push rod [4] through the handle bottom [2] into the connecting tube [5]. Before pushing the handle top [1] into the handle bottom [2] insert the two handle springs [3] [for the duel spring poop scooper] or insert the single spring [3] [for the single spring poop scooped]. Insert the hinge pin [8b] into the poop clamp [15] and through the connecting tube hinge [8], out the other side of the poop clamp [15], do this for both poop clamps [15]. Bolt the poop clamp spring [12] on to each one of the poop clamps [15] with the poop clamp spring bolt and nut [16]. Screw the push rod top nut [10] on the push rod [4]. Slide the push rod top washer [11] onto the push rod [4]. Slide both of the poop clamp springs [12] over the push rod [4]. Bolt on the two halves of the connecting tube hinge [8] together just above the connecting end stop [9] with the hinge bolt and nut [8a]. Slide the push rod bottom washer [13] over the push rod [4]. Screw the push rod bottom nut [14] onto the push rod [4]. Adjust the push rod top nut [10] and the push rod bottom nut [14] to desired location and tighten. Snap the holder for a roll of bags [6] onto the connecting tube [5].

### How to Use

Pull the poop scooper out of the belt clip. From the holder for a roll of bags, remove a bag. Slide the bag over the poop clamps. While holding the top of the bag roll the o ring down over the top of the bag. Compress the top handle into the bottom handle to open the poop clamps. While holding the poop clamps open push the bag up and into the bottom of the poop clamps. Release the tension on the handle, closing the poop clamps. When ready to use compress the top handle into the bottom handle opening the poop clamps. Reaching down place the poop scooper over the pet waste. Release the tension on the handle, closing the poop clamps pulling pet waste up and into the bag. Roll the o ring up and off of the top of the bag. Pull the bag down off of the poop clamps. Tie the top end of the bag. Compress the top handle into the bottom handle, opening the poop clamps. Remove the bag of pet waste and dispose of it. Put the poop scooper back in the belt clip.

### SEQUENCE LISTING

Not Applicable

1. A sanitary way of collecting pet waste comprising of a poop scooper with either a duel spring in the handle or a single spring in the handle, a connecting tube a push rod, poop clamps, a hinge, a bag holder, bags, an o ring and a belt clip. Remove the Poop Scooper from the Belt Clip, remove a bag from the bag holder, slide the bag over the scooper clamps. Roll the o ring over the top of the bag, compress the handle to open the scooper, push the bag up inside the scooper clamps. Place the scooper over the pet waste, release the tension on the handle allowing the scooper to pull the pet waste up and into the bag and closing the scooper. Remove the bag by sliding the o ring off of the top of the bag, then pull the bag down off of the clamps. Tie the top of the bag. Open the clamps by compressing the handle. Remove the bag and dispose of the bag of pet waste. Put the Poop Scooper back in the Belt Clip. Never touching the Poop with your hands, or having to scrape and wash off the poop from the Poop Scooper.

2. The sanitary way of collecting waste in claim 1, can also be used to pick up not only pet waste but anything that you want to collect in a bag to throw away or save, without touching it with your hands.

3. The sanitary way of collecting waste in claim 2, is light, compact, and able to be put in a clip on your belt.
